(19) United States
(12) Patent Application Publication
(10) Pub. No.: US 2026/0092523 A1
(43) Pub. Date: Apr. 2, 2026

(54) SYSTEM AND METHOD FOR SELECTING DRILLING RECIPES BASED ON ROCK HARDNESS

(71) Applicant: SANDVIK MINING AND CONSTRUCTION USA, LLC, Alachua, FL (US)

(72) Inventor: Toni PELTOMAA, Alachua, FL (US)

(21) Appl. No.: 19/343,389

(22) Filed: Sep. 29, 2025

Related U.S. Application Data
(60) Provisional application No. 63/700,920, filed on Sep. 30, 2024.

(51) Int. Cl. E21C 39/00; G06F 18/22

(52) U.S. Cl. CPC E21C 39/00; G06F 18/22

(57) ABSTRACT

A system for selecting a drilling recipe based on rock hardness for a mining vehicle, the mining vehicle including a processor and at least one memory including computer program code stored on a non-transitory computer-readable medium, the at least one memory and the computer program code being configured to, when executed by the at least one processor, cause the system at least to: receive data about rock formation, including data related to rock hardness, while drilling; analyze the rock hardness data to determine a hardness of the rock formation; retrieve at least one drilling recipe stored in the processor that is associated with similar rock formations; continuously monitor and receive rock hardness data as drilling continues along a hole depth; and select a different stored drill recipe if a change in rock hardness is detected.

### RELATED APPLICATION DATA

This application claims priority of U.S. Provisional Application No. 63/700,920, filed Sep. 30, 2024, which the entirety thereof is incorporated herein by reference.

### TECHNICAL FIELD

The present disclosure relates to a system and method to automatically select drilling modes/recipes based on rock hardness.

### BACKGROUND

As rock is typically formed of a mixture of materials, it combines not only the properties of these different minerals, but also exhibit properties resulting from the way in which the rocks were formed or subsequently altered due to water, heat, pressure, etc.

For example, microscopic rock properties include mineral composition, grain size, grain distribution etc., and these properties impact rock hardness, abrasiveness, density, etc. In turn, these rock properties determine the penetration rate that can be achieved during drilling and impact the choice and rate of wear on the drilling equipment. Thus, different rock impacts wear on drill bits and hence drillability depends on the hardness of the rock's minerals and grain size.

Identifying rock properties can be done by core sampling testing, however, as is well known, this method is very expensive and time consuming, thus making it unfeasible to core an entire length of a borehole. Also, rock hardness can vary throughout the rock formation and change quite rapidly. Hence, the data obtained via the core sampling does not provide a continuum of rock properties throughout the depth of the borehole or rock formation.

Known factors of drillability include likely tool penetration rate in proportion to tool wear, the qualities of the hole, such as straightness, and any tendency towards tool jamming. As discussed supra, rock drillability is also determined by several factors such as mineral composition, grain size and brittleness.

The amount of drilling that a drill bit can be used before it needs to be replaced depends on these rock characteristics, namely hardness. As changing drill bits is a time consuming event and expensive, it is desirable to maximize drill bit life. Matching the drill/drill bit to rock characteristics results in less wear and downtime. As such, it is known to provide drilling recipes to maximize drill bit selection.

Drilling through rock involves a combination of techniques, tools, and strategies tailored to the specific hardness of the rock. Currently an operator defines drill recipes and selects them based on the location and drilling conditions of the drill site.

A recipe can be a set of drilling values for a drilling domain, for example, soft rock, medium rock, hard rock. A recipe can include, but not limited to, collaring settings and full power setting, which take into account rotation speed, rotation pressure limit, feed speed, feed force limit, flushing flow and water flow, for example.

Accordingly, this means that even in fully autonomous drills, the operator still needs to interact with the rig to select the correct recipe for the present drilling conditions. This selected recipe then has to be swapped or changed by the operator when drilling conditions change.

Thus, there is a need for the rock drilling system to automatically select and change to a recipe based on rock hardness or other factors.

### SUMMARY

Harder rocks necessitate more energy to drill, leading to higher specific energy values. The relationship between rock hardness and specific energy is crucial in various drilling and cutting processes. When dealing with rock materials, hardness significantly impacts the energy required for removal. Specific energy refers to the amount of energy needed to extract a unit volume of rock during drilling or cutting operations. Rock hardness and specific energy are interconnected via several parameters, for example, as rock hardness increases, the penetration rate, i.e., how quickly a drill penetrates the rock, tends to decrease. Understanding this relationship aids in efficient rock removal and project success.

Thus, the use of knowledge of rock hardness optimizes drilling processes and predicting specific energy helps plan drilling projects more efficiently.

According to an example embodiment, a system for selecting a drilling recipe based on rock hardness for a mining vehicle, the mining vehicle including a processor and at least one memory including computer program code stored on a non-transitory computer-readable medium, the at least one memory and the computer program code being configured to, when executed by the at least one processor, cause the system at least to: receive data about rock formation, including data related to rock hardness, while drilling; analyze the rock hardness data to determine a hardness of the rock formation; retrieve at least one drilling recipe stored in the processor that is associated with similar rock formations; continuously monitor and receive rock hardness data as drilling continues along a hole depth; and select a different stored drill recipe if a change in rock hardness is detected.

According to an example embodiment, the rock formation data is obtained from one or more sensors arranged to collect data from measurements like rotation force, feed force, feed speed and rotation speed.

According to an example embodiment, the data includes at least one set of data values representative of the rock hardness of the rock formation along a hole created by the drill bit interacting with the rock formation in real time.

According to an example embodiment, the at least one set of data values is measure-while-drilling (MWD) data that includes, for example, key readings used such as feed pressure up and down to calculate feed force from the motor or cylinder, rotation pressure and speed to calculate rotation torque, feed speed (from absolute encoder) to measure penetration rate, and/or flushing pressure, compressor inlet pressure and compressor inlet temperature.

According to an example embodiment, the at least one recipe can include collaring settings and full power settings of the drill bit, which take into account rotation speed, rotation pressure limit, feed speed, feed force limit, flushing flow and water flow.

According to an example embodiment, the system is further configured to compare the retrieved recipe to other recipes stored in the processor before selecting the different stored recipe.

According to an example embodiment, the at least one recipe comprises a plurality of drilling recipes stored in the processor, each of the plurality of recipes defining a different rock hardness level.

According to an example embodiment, the rock hardness level is the specific energy needed to break the rock.

According to an example embodiment, a method performed by a system for a mining vehicle, the mining vehicle including a processor and at least one memory including computer program code stored on a non-transitory computer-readable medium, the at least one memory and the computer program code being configured to, when executed by the at least one processor, cause the apparatus to perform a method for selecting a drilling recipe based on rock hardness, the method comprises the steps of: receiving data about a rock formation, including information related to rock hardness, while drilling; analyzing the rock hardness data to determine a hardness of the rock; retrieving at least one drilling recipe stored in the processor that is associated with similar rock formations; continuously monitoring and receiving rock hardness data as drilling continues along a hole depth; and selecting a different stored drill recipe if a change in rock hardness is detected.

According to an example embodiment, a method for selecting a drilling recipe based on rock hardness in a mining vehicle comprises the steps of: categorizing rock formation at a drill site into a plurality of hardness levels; defining a drilling recipe with settings for each plurality of hardness levels; inputting each recipe into a processor of the mining vehicle; receiving rock formation data, including information related to rock hardness, while drilling; analyzing the rock hardness data to determine a hardness of the rock; retrieving at least one drilling recipe stored in the processor that is associated with similar rock formations; continuously monitoring and receiving rock hardness data as drilling continues along a hole depth; and selecting a different stored drill recipe if a change in rock hardness is detected.

According to an example embodiment, a computer program product comprises a non-transitory computer-readable storage medium including instructions, which, when executed on a computer, performs a method according to the present disclosure.

The foregoing summary, as well as the following detailed description of the embodiments, will be better understood when read in conjunction with the appended drawings. It should be understood that the embodiments depicted are not limited to the precise arrangements and instrumentalities shown.

### BRIEF DESCRIPTION OF THE DRAWINGS

FIG. 1 is a side view of a drill rig according to the present disclosure.

FIGS. 2A and 2B illustrate a control system and apparatus of the rig of FIG. 1.

FIG. 3 is a graph illustrating the relationship between rock hardness and a set value for a particular drilling recipe R1, R2, R3, etc.

FIG. 4 illustrates a flowchart of steps taken in an exemplary embodiment of the present disclosure for automatically determining a drilling recipe corresponding to the rock hardness of the rock formation being drilled.

### DETAILED DESCRIPTION

The present disclosure relates generally to a method of determining and selecting a drilling recipe corresponding to the rock hardness and any changes therein as the hole is being drilled. It should be appreciated that other rock properties that may be determined include, but is not limited to, rock compressive strength and rock porosity. These properties are determined at real-time or at near real-time so that appropriate selection/modifications of the recipe may be made while drilling

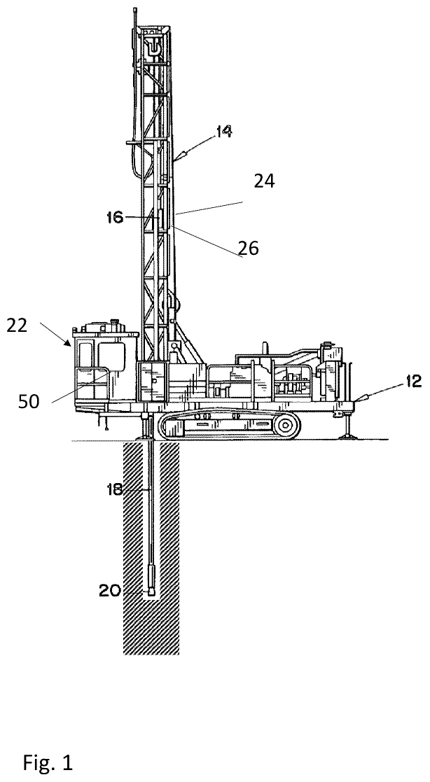

As shown in FIG. 1, a mining vehicle 10, such as a rotary drill rig, includes a mobile deck or carriage 12 and a mast 14 mounted on the carriage. Mining vehicle 10 can be a boom drill, a down-the-hole percussive (DTH) drill rig or a rotary blasthole drill rig. It should be appreciated that other types of vehicles are contemplated and the present disclosure is not limited to mining vehicles or a particular type of mining vehicle.

Mast 14 is movable between a horizontal, stored position and a vertical position as shown. The mast carries a rotary head 16 which is capable of rotating a drill string 18 to which a drill bit 20 is mounted. The rotary head 16 can be raised and lowered to enable pipes to be removed or added to the drill string.

A cab 22 is also provided on carriage 12. The vehicle is powered by a drive assembly, which includes known components, such as a motor that provides the necessary power to drive various components of the rig. Vehicle 10 also includes other conventional components, such as a compressor, which supplies high-pressure air needed for drilling and flushing cuttings out of the borehole.

The drilling rig 10 may also be autonomous and remote-controlled.

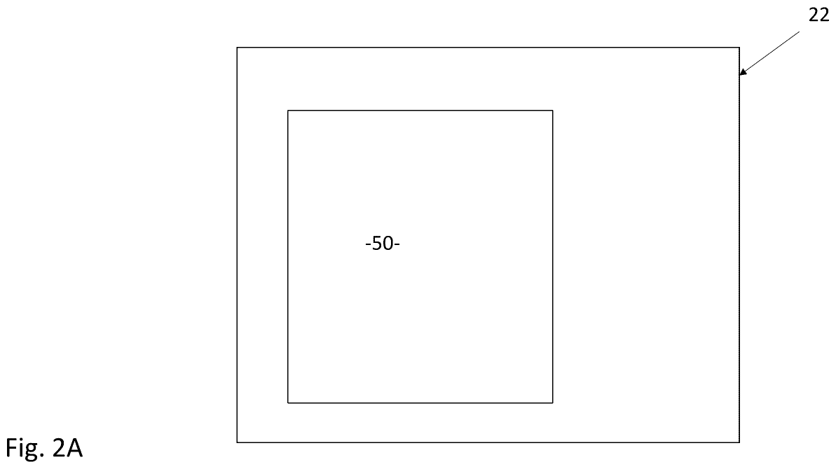

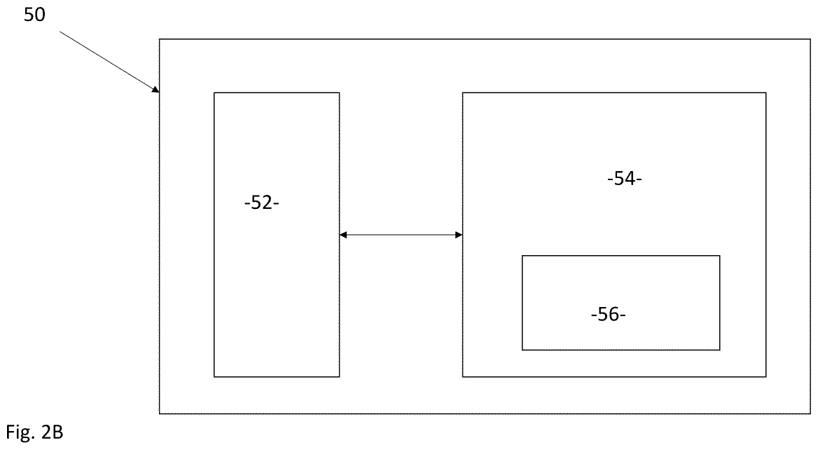

Referring to FIG. 2A, disposed within cab 22 is a control unit 50. As will be described further herein, control unit 50 includes controls for operating the drill rig, such as programmable logic controllers, and controller area network based database for processing and displaying data obtained from sensors 24.

As will be described further herein, rock formation data is obtained from the one or more sensors 24 that are positioned on rotary head 16, for example, as drilling occurs along a hole that is created by the drill bit interacting with the rock formation of the hole. The data, like rotation force, feed force, feed speed and rotation speed, which can be at least one set of data values representative of rock hardness can be provided on a real time basis drilling data from at least one hole into the database, and future drilling actions for the hole utilizing the drilling data within the database can be executed. Sensor(s) 24 receive values associated with at least one drilling parameter as described herein.

As described further below, control unit or apparatus 50 includes a device including a microprocessor and/or a signal processor and possibly memory capacity external thereto in order to execute necessary calculation and comparison procedures by the software contained therein. FIG. 2A schematically shows the control unit 50. It should be appreciated that FIG. 2A is not limiting, and the control unit 50 may include other and further components relevant to its function.

Referring to FIG. 2B, control unit 50 includes processor 52, which may be a programmable digital computer, at least one memory 54, such as a non-transitory computer readable storage medium for storing instructions executable by the processor (such as a random-access memory) and a hard drive or flash memory or the like for further storage of programs and data, as well as input and output ports.

There is provided a computer program, a computer program product or computer-readable medium 56 including computer program code for, when executed in a data processor, causes the system to perform the method or an embodiment thereof. In other words, the computer program may include computer readable code means, which when run by the system causes the device/system to perform the method steps described in any of the described embodiments. The computer program may be carried by a computer program product connectable to the processing circuitry. The computer program product may be the memory. The memory may be realized as for example a RAM (Random-access memory), ROM (Read-Only Memory) or an EEPROM (Electrical Erasable Programmable ROM). Further, the computer program may be carried by a separate computer-readable medium, such as a CD, DVD or flash memory, from which the program could be downloaded into the memory. Alternatively, the computer program may be stored on a server or any other entity connected to the system. The computer program may then be downloaded from the server into the memory. The method(s) may thus be computer-implemented based algorithm(s) executable by the generic processing functions, an example of which is the at least one processor.

Control unit 50 enables different operation modes adapted to different kinds of rock parameters to be selected so that operation of the mining vehicle is based on the kind of rock to be drilled. Thus, with rock hardness as a signal, the system can automatically select a recipe based on the rock hardness.

As discussed supra, it is useful to have knowledge of the properties of the rock being drilled, such as strength and hardness. Rock hardness can be measured via known tests. Hardness and other parameter data can also be determined during drilling. This data is referred to as “measurement-while-drilling” (MWD) data. The MWD data can then be related to the physical properties of the rock being drilled. Multiple sensors 24, via equation calculations generate MWD data indicative of the specific energy—i.e., the hardness of the rock being drilled.

Such MWD data can include key readings used such as feed pressure up and down to calculate feed force from the motor or cylinder, rotation pressure and speed to calculate rotation torque, feed speed (from absolute encoder) to measure penetration rate, and/or flushing pressure, compressor inlet pressure and compressor inlet temperature to calculate flushing flow. Further, but is not limited to inclination, direction, downhole weight on bit, downhole torque, resistivity and the like

As described above, control unit 50 has data storage for storing an array of measured rock hardness data generated by the sensors and previously stored data information referred to as the recipes. This data is used to calculate specific energy via the processor and based on the calculated specific energy, the rock hardness. Implementation of the measured data is used to calibrate based on the available measurements and as such the recipes will be relative to the actual output.

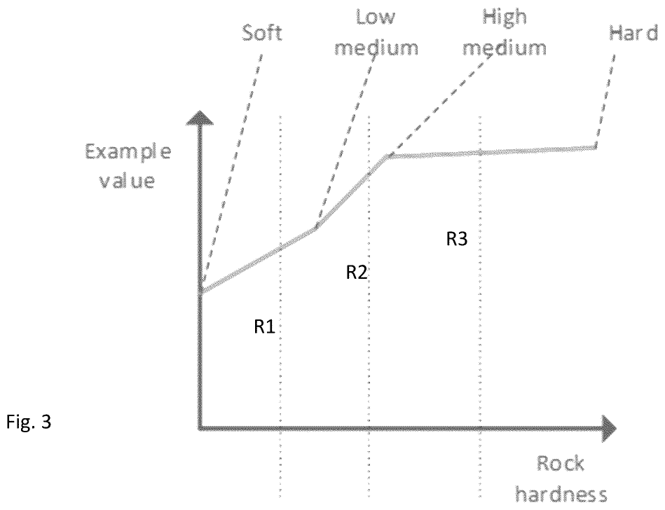

Referring to FIG. 3, the recipe is a set of drilling values for a drilling domain that is categorized as soft rock, medium rock, or hard rock. A mine site can define a multitude of hardness domains. For example, for “soft” rock could be defined as rock with a hardness of approximately 5,000 psi, “medium” hard rock is defined as rock having a hardness between 5,000 psi and 25,000 psi and “hard” rock is defined as rock with a hardness exceeding 25,000 psi. However, it should be appreciated that the mine site could have more than 100 domains/recipes, not just three defined as soft, medium or hard.

Referring to FIG. 3, and as described supra, the recipe is a set of drilling values for a drilling domain. A recipe can consist of, but not limited to, the collaring settings and full power settings selected from: rotation speed, rotation pressure or torque limit, feed speed, feed pressure or force limit, flushing flow, and water flow.

It should be appreciated that the above information is geo-location based.

FIG. 3 illustrates the relationship between rock hardness and a set of values between different recipes R1, R2, R3 . . . (shown in dotted lines), for the varying rock hardness's. The graph shows for example, a set example value for flushing flow and how the value increases between soft, medium and hard rock hardness. Flushing flow typically relates to the fluid flow, i.e., of water, through rock fractures, boreholes, or other pathways. In drilling and mining operations, flushing flow is crucial for removing cuttings, cooling drill bits, and maintaining borehole stability.

Although not shown by FIG. 3 it should be appreciated that rotation speed vs. rock hardness can be illustrated. The rotation speed, in the context of rock drilling or cutting, refers to the rate at which a tool (such as a drill bit or cutter) rotates. It affects the efficiency of material removal, heat generation, and wear on the drilling tool. The rotation speed value can be illustrated on the Y-axis, in RPM, wherein the softer rocks (lower hardness) allow higher rotation speeds due to easier material removal. Harder rocks would show slower rotation.

Rotation pressure limit could also be illustrated graphically. Rotation pressure limit, in the context of rock drilling or cutting, refers to the maximum pressure applied during the rotation of a tool, such as a drill bit or cutter. Softer rocks with lower hardness allow higher rotation pressure limits due to easier material removal. Harder rocks (higher hardness) require lower rotation pressure limits to prevent excessive wear and heat.

It should be appreciated that feed speed, feed force limit and water flow can similarly be graphically represented as shown in FIG. 3.

Thus, the recipes R1, R2, R3 for a particular value such as are set in the system. The recipe includes, but is not limited to, collaring settings and full power settings, each of which include rotation speed, rotation pressure limit, feed speed, feed force limit, flushing flow and water flow. The recipes can be chosen by the operator and input into the control system as described.

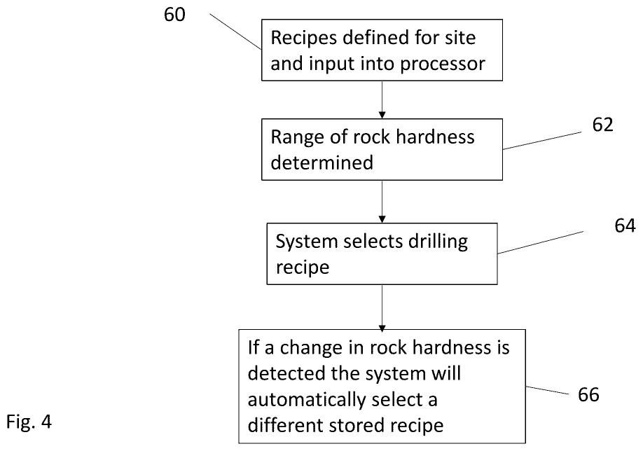

FIG. 4 is a block diagram depicting the system in accordance with an example embodiment of the present disclosure. In step 60, an operator defines drilling recipes with settings for each of the plurality of hardness levels reflecting the range of rock hardness in a manner as described above, and the same is input into the processor 52 via control unit 50. Although three recipes are illustrated in FIG. 3, it should be appreciated that more than three recipes can be chosen and input by the operator. There will be an actual number of recipes created.

In step 62, a range of rock hardness is determined in the hole being drilled. As described supra, at least one sensor 24 can generate MWD data indicative of the hardness of the rock being drilled along the length of the hole as the drill bit interfaces with the rock formation. Thus, the range of rock hardness is defined by the site. The first site where the testing is done has already defined 3 domains: soft, medium and hard. Recipe settings for the different domains have also been defined.

In step 64, the processor automatically selects the correct recipe to the present rock conditions. For example, the system has two recipes-one set for value hardness 10 and two set to hardness 20. The rock hardness measurement from MWD-A is 15. Inside the recipe one has a flushing flow defined to be 50% and on the recipe with two we have flushing flow defined to be 100%. In this case the system uses 75% as it is in the middle of the two points.

In known practice, the operator at the site changes the settings of the drill whenever their geological map shows that the rock hardness changes. However, the present system continues to monitor and receive the rock hardness data (MWD) as drilling continues. In step 66, if a change in rock harness is detected and since there are three or more recipes in the system, which all are set for range of different rock hardness, the present system will automatically and adaptively adjust between the recipes, for example, R1, R2, R3 as shown in FIG. 3.

While rock hardness constantly varies inside the hole, the system can automatically drift between the setpoints of R1, R2, R3 etc. The system will constantly adjust the target based on the MWD hardness output.

Accordingly, once the recipes are defined for the site, the operator doesn't have to interact with the rig and select recipes for different drilling conditions. However, the operator has the ability to fine tune a recipe and the system will adjust to take into effect. For example, the operator can still interact with the recipes as they keep drilling and the drill will still store the adjustments for the next hole (or not if chosen so). Moreover, the system can adjust, for example, two recipes at a time.

What is claimed is:

1. A system for selecting a drilling recipe based on rock hardness for a mining vehicle, the mining vehicle including a processor and at least one memory including computer program code stored on a non-transitory computer-readable medium, the at least one memory and the computer program code being configured to, when executed by the at least one processor, cause the system at least to:
receive data about rock formation, including data related to rock hardness, while drilling;
analyze the rock hardness data to determine a hardness of the rock formation;
retrieve at least one drilling recipe stored in the processor that is associated with similar rock formations;
continuously monitor and receive rock hardness data as drilling continues along a hole depth; and
select a different stored drill recipe if a change in rock hardness is detected.

2. The system of claim 1, wherein the rock formation data is obtained from one or more sensors arranged to collect data from measurements like rotation force, feed force, feed speed and rotation speed.

3. The system of claim 2, wherein the data includes at least one set of data values representative of the rock hardness of the rock formation along a hole created by the drill bit interacting with the rock formation in real time.

4. The system of claim 3, where the at least one set of data values is measure-while-drilling (MWD) data that includes inclination of the bit, direction of the bit, downhole weight on bit, and downhole torque.

5. The system of claim 1, wherein the at least one recipe can include collaring settings and full power settings of the drill bit, which take into account rotation speed, rotation pressure limit, feed speed, feed force limit, flushing flow and water flow.

6. The system of claim 1, further configured to compare the retrieved recipe to other recipes stored in the processor before selecting the different stored recipe.

7. The system of claim 1, wherein the at least one recipe comprises a plurality of drilling recipes stored in the processor, each of the plurality of recipes defining a different rock hardness level.

8. A method performed by a system for a mining vehicle, the mining vehicle including a processor and at least one memory including computer program code stored on a non-transitory computer-readable medium, the at least one memory and the computer program code being configured to, when executed by the at least one processor, cause the apparatus to perform a method for selecting a drilling recipe based on rock hardness, the method comprising the steps of:
receiving data about a rock formation, including information related to rock hardness, while drilling;
analyzing the rock hardness data to determine a hardness of the rock;
retrieving at least one drilling recipe stored in the processor that is associated with similar rock formations;
continuously monitoring and receiving rock hardness data as drilling continues along a hole depth; and
selecting a different stored drill recipe if a change in rock hardness is detected.

9. A method for selecting a drilling recipe based on rock hardness in a mining vehicle, the method comprising the steps of:
categorizing rock formation at a drill site into a plurality of hardness levels;
defining a drilling recipe with settings for each plurality of hardness levels;
inputting each recipe into a processor of the mining vehicle;
receiving rock formation data, including information related to rock hardness, while drilling;
analyzing the rock hardness data to determine a hardness of the rock;
retrieving at least one drilling recipe stored in the processor that is associated with similar rock formations;
continuously monitoring and receiving rock hardness data as drilling continues along a hole depth; and
selecting a different stored drill recipe if a change in rock hardness is detected.

10. A computer program product comprising a non-transitory computer-readable storage medium including instructions, which, when executed on a computer, performs a method according to claim 9.
